(19) United States
(12) Patent Application Publication
(10) Pub. No.: US 2025/0190495 A1
(43) Pub. Date: Jun. 12, 2025

(54) OPTIMIZING CONTENT SERVICE THROUGH FINITE STATE MACHINE

(71) Applicant: Microsoft Technology Licensing, LLC, Redmond, WA (US)

(72) Inventors: Pengcheng XIONG, San Jose, CA (US); Zhong WU, Kirkland, WA (US); Kuan-Ting LAI, Redmond, WA (US)

(21) Appl. No.: 18/536,306

(22) Filed: Dec. 12, 2023

(51) Int. Cl. G06F 16/906

(52) U.S. Cl. CPC G06F 16/906; G06N 5/048; H04L 67/50

(57) ABSTRACT

Aspects of the disclosure include methods and systems for optimizing content service through state-machine based goal programming. An exemplary method can include receiving, from a client, a card request for structured data cards and determining a state of the client. The method can include, based on the state of the client, selecting for inferencing, via a finite state machine, one of a first model and a second model, determining, from the respective model selected for inferencing, a ranking of a plurality of candidate structured data cards, and providing, to the client, a card response including one or more structured data cards of the plurality of candidate structured data cards according to the ranking.

### INTRODUCTION

The subject disclosure relates to content delivery, and particularly to optimizing content service through finite state-machine based goal programming.

Content service refers to the process of providing and distributing various types of content to users, often across different platforms and devices. Content service generally involves the transfer and routing of digital content, such as text, images, videos, audio, and software updates, from a content provider's server to a collection of end user devices. The digital content can include, for example, news articles, national and local weather updates and reports, trending stories, market and financial updates, and a variety of user and system level notifications.

A content delivery service often acts as an intermediary between the content providers and end users, ensuring efficient, fast, and secure delivery of the digital content between different devices and across various networks. Content delivery services can employ various techniques to enhance delivery performance. For example, incorporating content compression, protocol optimization, adaptive bitrate streaming, and using technologies like content preloading can ensure a smooth and uninterrupted user experience. By leveraging these and other techniques, such as caching, replication, intelligent routing, and performance optimization, content delivery services can enhance the user experience and can enable content providers to reach a wider audience effectively.

Content service delivery can be responsive, proactive, or use a combination of responsive and proactive content delivery techniques. A responsive content service delivery is driven by user interactions and requests. For example, sports-related content can be delivered to a user in response to specific user actions, such as making search queries for game score updates, clicking a sports widget, or otherwise explicitly requesting the content. In contrast, proactive content service delivery refers to the process of delivering content to end users without requiring explicit user interactions or requests. In this approach, the content is pushed to users proactively based on predefined criteria, such as user preferences, demographics, or a predetermined schedule. For example, a uniform content update can be pushed to all end user devices every 35 minutes.

### SUMMARY

Embodiments of the present disclosure are directed to methods for optimizing content service through state-machine based goal programming. A non-limiting example method includes receiving, from a client, a card request for structured data cards and determining a state of the client. The method can include, based on the state of the client, selecting for inferencing, via a finite state machine, one of a first model and a second model, determining, from the respective model selected for inferencing, a ranking of a plurality of candidate structured data cards, and providing, to the client, a card response including one or more structured data cards of the plurality of candidate structured data cards according to the ranking.

Embodiments of the present disclosure are directed to systems for optimizing content service through state-machine based goal programming. A non-limiting example system includes a finite state machine having a first state and a second state, a first model trained on training data, and a second model trained on the training data. While training the first model, samples in the training data are labeled as positive samples and negative samples according to whether each respective sample includes at least one of a first feature and a second feature. While training the second model, samples in the training data are labeled as positive samples and negative samples according to whether each respective sample includes the first feature. The system can include a switching module coupled to the finite state machine. The switching module is configured to select one of the first model and the second model for inferencing. The switching module selects the first model when the finite state machine is in the first state and the second model when the finite state machine is in the second state.

Embodiments of the present disclosure are directed to a computer program product for optimizing content service through state-machine based goal programming. A non-limiting example computer program product includes a computer readable storage medium having program instructions embodied therewith, the program instructions executable by one or more processors to cause the one or more processors to perform operations. The operations can include labeling training data by assigning a first set of positive labels and a first set of negative labels to samples in the training data according to whether each respective sample includes at least one of a first feature and a second feature and labeling the training data by assigning a second set of positive labels and a second set of negative labels to the samples according to whether each respective sample includes the first feature. The operations can include training a first model on the first set of positive labels and the first set of negative labels, training a second model on the second set of positive labels and the second set of negative labels, and selecting one of the first model and the second model for inferencing based on a state of a finite state machine.

The above features and advantages, and other features and advantages of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1A depicts an example content delivery system having a frame for content delivery in accordance with one or more embodiments;

FIG. 1B depicts an example new frame reached via a navigation link in the frame shown in FIG. 1A in accordance with one or more embodiments;

FIG. 2 depicts a block diagram of a content service delivery architecture for optimizing content service in accordance with one or more embodiments;

FIG. 3 depicts a block diagram of a computer system according to one or more embodiments; and

FIG. 4 depicts a flowchart of a method in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of the disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

Successful content service relies in part on the effective selection of digital content, such as a news feed, weather update, finance and market data, as well as images, videos, audio, and software updates, for delivery and/or routing to end users. Content service providers must carefully consider a number of factors, such as the nature of the content, its relevance to its intended audience, file sizes, network conditions, bandwidth limitations, and format compatibility with end user devices, when making these selections. Additionally, for personalized content delivery, learned user preferences and geographic localization can play a crucial role in tailoring the user experience.

User engagement metrics are another consideration content service providers often rely upon when selecting content. User engagement can be measured according to a variety of somewhat related metrics, such as the number of unique daily active users (DAU) and the number of page views (PV) per unique user.

DAU counts how many distinct users are active on a given content service delivery platform over the last 24 hours. DAU is a commonly tracked metric for many internet-based products because DAU is an effective proxy for product health by showing how many customers actually use the respective product. In an example, as used herein, DAU can be counted (incremented and/or increased) when a user has any click engagement with the content of interest, such as via a navigation click (e.g., selecting an embedded hyperlink to be directed to linked content) or non-navigation click (e.g., interacting with widgets provided with the content, such as the use of left/right page arrows, expand selection widgets, etc.).

PV, on the other hand, counts how many times users navigate to secondary content (also referred to as a landing page) by selecting (clicking through) a navigation click in the delivered content. Notably, users can further navigate to more pages after their first landing page and PV increments each time. That is, while DAU increments only once (a user either is or is not an active user for a given day), PV can increment an arbitrary number of times for each user as the respective user navigates through various landing pages via a succession of navigation links. PV is also an important user engagement metric as each visited landing page is an opportunity to further interact with the user (e.g., display ads and/or other monetization efforts, learn the content of interest to respective users, etc.).

When selecting content for delivery, service providers and content delivery services often attempt to maximize their user engagement metrics. For example, a service provider might want to serve or otherwise deliver content that will maximize DAU and/or DAU/UU (DAU per unique user) and PV and/or PV/UU (PV per unique user). This is, in essence, a multi-objective optimization problem and can, theoretically, be solved using linear programming.

Unfortunately, the solutions to optimize DAU/UU and PV/UU are empirically known to be in direct conflict with one another in many cases. Intuitively, this means that the characteristics of a given piece of content that are optimal for DAU conversion (e.g., flashy, bright, controversial, etc.) are not necessarily optimal for PV increases (e.g., more deeply aligned with a respective user's actual interests, etc.). Complicating matters further, there is often only one delivery order (ranking) of content that can be rendered to the end user. This is a consequence of inherently limited user interface space—there might only be room for N content of all possible content. The result is an inherent trade-off between optimizing DAU/UU and PV/UU when selecting content for delivery.

This disclosure introduces an intelligent content service delivery architecture that optimizes content service through state-machine based goal programming. Rather than attempting to optimize a trade-off between DAU/UU and PV/UU, the present architecture includes a content selection module that leverages a finite state machine and switching module to dynamically switch a content delivery optimization target between DAU and PV based on a current state of the user. As an example, as used herein, the “current state” of the user refers to whether the user is a DAU or a non-DAU.

In some embodiments, separate objective models are built for two or more optimization targets, including, for example, DAU and PV. The DAU model is trained to estimate how much its respective objective metric (DAU) can be increased by different candidate content, such as structured data cards including as weather cards, sports cards, finance cards, news cards, etc. Similarly, the PV model is trained to estimate how much its respective objective metric (PV) can be increased by the different candidate content.

In some embodiments, these separate estimates, one for each objective model, are output as predicted scores for each candidate content. In some embodiments, the predicted scores are ranked. In some embodiments, the N highest ranked candidate content are retained for candidate delivery, where N is at least one and is upper bound by a maximum number of content that can be concurrently shown to the respective user (limited, e.g., via the end device user interface, computing resources, etc.).

In some embodiments, the finite state machine is configured to determine a state (e.g., DAU vs. non-DAU) of a respective user. In some embodiments, the switching module is configured to activate one of the available objective models depending on the state determined by the finite state machine. In particular, the switching module is configured to activate one of the available objective models depending on whether the user is a DAU or non-DAU. For example, if the user is a DAU, the switching module activates the PV model and, if the user is a non-DAU, the switching module activates the DAU model.

An intelligent content service delivery architecture that optimizes content service through state-machine based goal programming in accordance with one or more embodiments offers several technical advantages over other content delivery systems. Notably, the content selection module described herein (via the finite state machine and the switching module) will select content that optimizes DAU conversions when needed (that is, for non-DAU users), while simultaneously selecting content that optimizes PV for users that are already within DAU. Other advantages are possible. For example, while all objective models can be run concurrently at run-time (that is, during inference), in other embodiments only the respective objective model activated via the switching module is run at each time step. Advantageously, limiting inference to the objective model selected according to the finite state machine reduces compute overhead and improves content service latency.

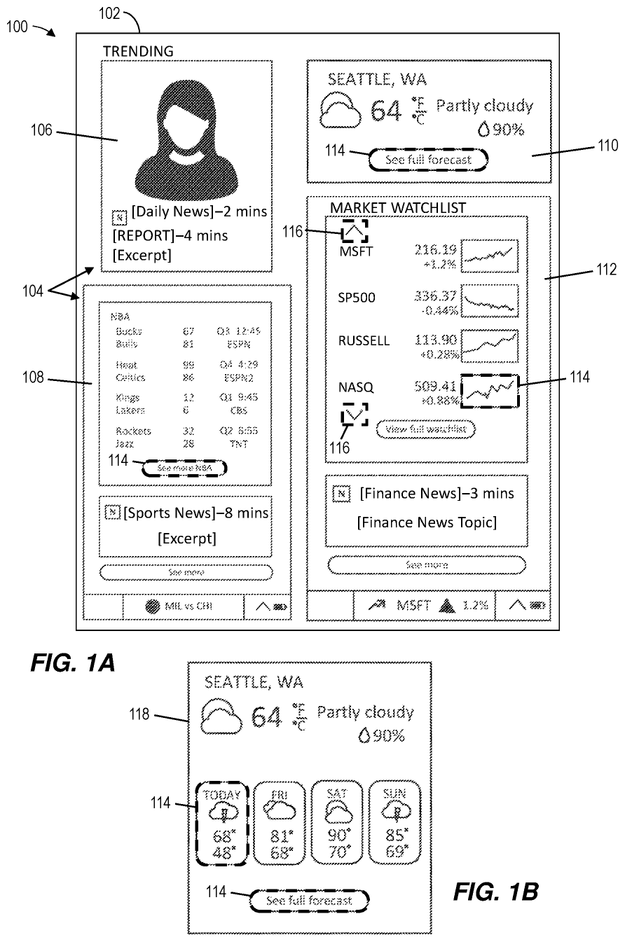

FIG. 1A illustrates an example content delivery system 100 having a frame 102 for content delivery in accordance with one or more embodiments of the present disclosure. The frame 102 is not meant to be particularly limited but can include, for example, a homepage of an internet browser of an end user device (e.g., the Edge homepage, new tab page, etc.), an operating system flyout (e.g., Windows 11 flyout, etc.), and/or any other graphical user interface (GUI) element configured to provide users with visual and/or textual data. In some embodiments, frame 102 is configured to display a set or collection of structured data (SD) cards 104. The SD cards 104 can provide predetermined structured data information, such as finance data, weather data, traffic data, etc., for millions or even billions of users. For example, the SD cards 104 can include a trending news SD card 106, a sports SD card 108, a weather SD card 110, a finance SD card 112, and/or any of a variety of other SD cards (e.g., content release cards, personalized recommendation cards, announcement cards, etc.).

In some embodiments, one or more of the SD cards 104 include navigation links 114 and/or non-navigation links 116. As used herein, a “navigation link” includes an actual widget and/or embedded code within an SD card 104 that causes, upon selection by a user, a user device to navigate to linked content (the content accessed via the selection). In contrast, as used herein, a “non-navigation link” includes an actual widget and/or embedded code within an SD card 104 that allows manipulation and/or other customization of what is shown in the respective SD card 104 but does not cause the user device to navigate to linked content.

To illustrate, consider a scenario where a user is provided the frame 102 within, for example, an operating system flyout. Consider further that the user selects the “up arrow” and/or “down arrow” shown in the finance SD card 112 and denoted as non-navigation links 116. Selection of either of these non-navigation links 116 causes the finance SD card 112 to scroll through and/or rotate higher, or lower, respectively, the shown selection of companies. That is, selection of the down arrow non-navigation link 116 causes the finance SD card 112 to show the next entity below “NASQ”, and selection of the up arrow non-navigation link 116 causes the finance SD card 112 to show the next entity above “MSFT”. Observe that the user remains within frame 102.

Now consider that the user selects the “See full forecast” link shown in the weather SD card 110 and denoted as a navigation link 114. Selection of this navigation link 114 causes the content delivery system 100 (via, e.g., a device user interface, refer to FIG. 5) to navigate from frame 102 to a new frame 118, shown in FIG. 1B. While not meant to be particularly limited, frame 118 might include, for example, a weather service landing page and/or other web page opened via an internet browser (not separately shown) of the content delivery system 100. In some embodiments, frame 118 (e.g., the landing page) itself includes one or more navigation links 114 which, upon selection, direct the content delivery system 100 to yet more landing pages. Observe that a user might be directed from frame to frame in this manner over the course of a session (e.g., a period of time over which the respective user interacts with the content delivery system 100).

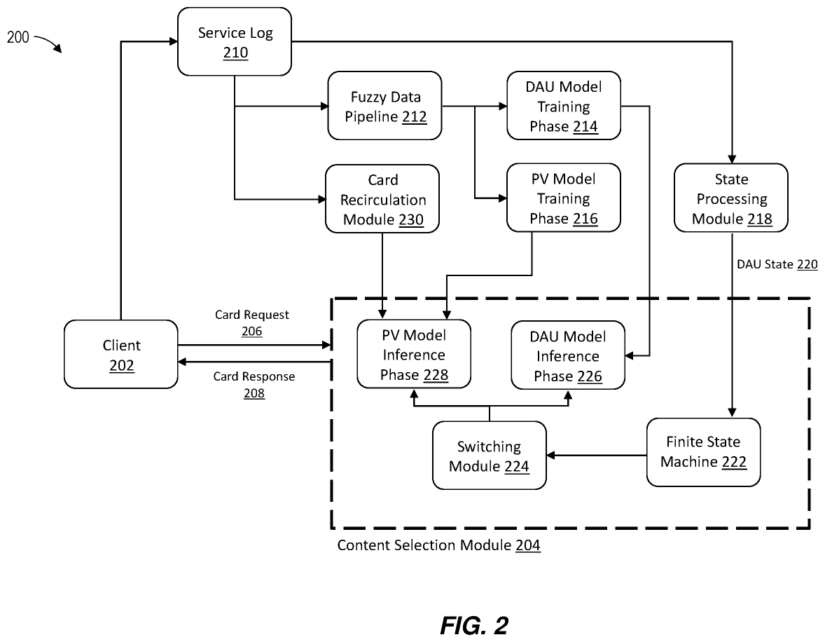

FIG. 2 depicts a content service delivery architecture 200 for selecting content (e.g., the SD cards 104 of FIG. 1A) to optimize content service in accordance with one or more embodiments of the present disclosure. As shown in FIG. 2, the content service delivery architecture 200 includes a client 202 communicatively coupled to a content selection module 204. The client 202 is not meant to be particularly limited, but can include, for example, the content delivery system 100 of FIG. 1A and/or a user device having therein the content delivery system 100.

In some embodiments, client 202 requests content (e.g., SD cards 104) from the content selection module 204. This process can be referred to as a card request 206. While discussed primarily in the context of card requests for ease of discussion and illustration, it should be understood that the client 202 can make requests for any type of content and all such configurations are within the contemplated scope of this disclosure.

In some embodiments, the content selection module 204, in response to receiving the card request 206, can deliver one or more content items (e.g., SD cards 104) to the client 202. This process can be referred to as a card response 208. The following discussion will explore how content selection module 204 chooses SD cards (or other content) to include in the card response 208.

In some embodiments, the content service delivery architecture 200 includes a service log 210. The service log 210 maintains a record of client-side actions (also referred to as an action sequence) for the client 202 and any number of additional clients (not separately shown). In some embodiments, the service log 210 tracks actions with respect to the content delivery system 100, such as selections made within the frame 102 and/or frame 118 described with respect to FIGS. 1A and 1B. For example, the service log 210 can track whether the client 202 interacted with (selected, hovered over, etc.) any of the navigation links 114, non-navigation links 116, and/or any other content of the frames 102 and 118.

In some embodiments, all or a portion of the service log 210 is provided to a fuzzy data pipeline 212 (also referred to as a fuzzy data extraction). In some embodiments, the fuzzy data pipeline 212 extracts, from the service log 210, so-called “fuzzy data”, which is data sourced from a special, relatively small percentage of client interactions (e.g., less than 5 percent total traffic) in which all available SD cards 104 are randomly ranked for users instead of assigned via the content selection module 204. Advantageously, the click and view actions of the randomly ranked SD cards 104 (that is, the fuzzy data) will be free of any position biases for the client 202 because the random placement of SD cards 104 gives every candidate SD card an equal chance to be shown to the client 202.

To illustrate, consider a scenario in which the available SD cards 104 are a weather card, a sports card, a finance card, and a shopping card. To generate fuzzy data, a small portion of SD cards 104 provided to users (e.g., the client 202 via card response 208) are randomly shuffled. The resultant fuzzy data includes the order of the randomly shuffled SD cards 104 (e.g., finance card, shopping card, weather card, and sports card) as well as a list of any interactions of the client 202 with the respective navigation links 114 and/or non-navigation links 116 found therein. Continuing with the previous example, the fuzzy data might include data indicating that the client 202 clicked one of the navigation links 114 in the finance card and interacted with one or more non-navigation links 116 in the sports card.

In some embodiments, the fuzzy data filtered from the service log 210 by the fuzzy data pipeline 212 is served as training data for a DAU model training phase 214 and a PV model training phase 216. In some embodiments, the DAU model and PV model are models trained to predict which SD cards will optimize DAU and PV, respectively (these models are not shown separately from their respective training and inference phases).

Turning first to the DAU model, in some embodiments, the DAU model training phase 214 can include the identification and labeling of positive and negative samples within the fuzzy data. For example, samples with a positive label for DAU optimization can include card responses 208 that resulted in the client 202 selecting and/or otherwise interacting with the navigation links 114 and/or non-navigation links 116 (that is, efforts that would result in converting a non-DAU user to a DAU). Continuing with the prior example, positives labels can be assigned to the finance card and the sports card (the user 202 clicked one of the navigation links 114 in the finance card and interacted with one or more non-navigation links 116 in the sports card). On the other hand, negative labels can be assigned to any cards viewed by the client 202 after receiving the card response 208 that were not interacted with (e.g., the shopping and weather cards in the prior example).

In some embodiments, each training data (the positive and negative samples) is defined in terms of a plurality of input features during the DAU model training phase 214. For example, in some embodiments, a binary classification model (positive vs. negative sample) is leveraged to train a fast tree classifier model using the features shown in Table 1. Note that the particular features described in Table 1 are illustrative only and are not meant to be exhaustive or particularly limited. Other features are possible and all such configurations are within the contemplated scope of this disclosure. Features can include, generally, information about the client 202 (e.g., user-specific metadata, learned longer term interests, preferences, demographic information, historic usage data, etc.), metadata regarding the content provided within the SD cards themselves (e.g., what type of content, what time of day is it, is the stock market open, is it raining, etc.), engagement feature metadata (e.g., what is the time since last request, how many users interacted with the weather card within the prior 2 hours, 12 hours, 24 hours, etc.), context features (e.g., what was the time of the card request 206, what is the user's current location, etc.), and/or any other metadata.

TABLE 1
Feature Types

| Type | Description/Details | Examples |
|---|---|---|
| User Long | Users' action | Number of sports card interactions |
| Term | during past | with navigation links 114 and/or |
| Interest | N days, such as | non-navigation links 116 in past |
| Features | click count, | 30/10/1 day(s). |
| | view count, | Counter for number of times a |
| | historical CTR, | “top stories” card was clicked |
| | vertical | in past 30 days. |
| | engagement, etc. | User 30 day CTR of finance card. |
| | | Tagged interests in user's OS and/or |
| | | browser profile. |
| | | Users subscribe to “Sports” interest |
| | | in OS profile. |
| | | User searches finance related content. |
| Content | Features | IsLive indicator that returns true |
| Features | describing the | when the respective sports game |
| | content, such as | is live. |
| | entity identifiers | IsMarketOpen indicator that returns |
| | for cards, | true when the stock market is open. |
| | whether the data | entityId that indicates type of sports |
| | is “live”, | game, such as NBA, MLB, NHL, etc. |
| | indicators for | |
| | severe weather, | |
| | etc. | |
| Near Real | Various time | Count of users that have viewed the |
| Time | increments, | weather card in past 2 h, 6 h, etc. |
| Engagement | such as 2 h, | Count of users that have “liked” a |
| Features | 6 h, 12 h, 24 h, | news card widget/item over last hour, |
| | 30 days, etc. | etc. |
| Request | Data and | Local time when card request 206 |
| Context | metadata for | was received, e.g., a range from |
| Features | the card request | 1 to 24. |
| | 206 itself, | Location: e.g., US, UK, JP, etc. |
| | such as time, | IsLogin: an indicator for whether |
| | location, | the user is logged into a particular |
| | whether the | service delivery account or |
| | user is logged | is merely a guest. |
| | into a particular | |
| | service, etc. | |

In some embodiments, the DAU model training phase 214 includes determining the weights of the nodes of one or more hidden layers of the DAU model (not separately shown). In some embodiments, the weights of the nodes are determined by successively inputting different feature vectors (e.g., a range of positive and negative samples having different feature spaces) into the model and, for each training input, adjusting one or more weights until the SD cards predicted by the DAU model to optimize DAU match the known labels. In short, weights can be adjusted during the DAU model training phase 214 until the DAU model provides reasonable (within any level of accuracy, subject only to training time and depth) selections of SD cards to optimize DAU. Advantageously, the DAU model training phase 214 relies upon fuzzy data (refer to the fuzzy data pipeline 212), and the result is a trained DAU model that is free of position bias. In contrast, training the DAU model without the fuzzy data collected via the fuzzy data pipeline 212 can result in the model becoming biased towards SD cards 104 that were prominently placed (e.g., first, at the top, etc.) during the collection of the data for the service log 210.

Turning now to the PV model, in some embodiments, the PV model training phase 216 can include the identification and labeling of positive and negative samples within the fuzzy data, in a similar manner as described with respect to the DAU model. Notably, however, unlike the positive samples used when training the DAU model, only card requests 206 that resulted in actual selections of navigation links 114 are included in the positive samples for the PV model (that is, only efforts that would result in increasing PV are relevant, and the conversion of a non-DAU user to a DAU is not considered). Continuing with the prior example, only the finance card is labeled as a positive sample (the user 202 clicked one of the navigation links 114 in the finance card). All other cards are labeled as negative samples (including the sports card labeled as a positive sample by the DAU model, as the user only interacted with the non-navigation links 116 of the sports card).

In some embodiments, each training data (the positive and negative samples) is defined in terms of a plurality of input features during the PV model training phase 216. For example, in some embodiments, a binary classification model (positive vs. negative sample) is leveraged to train a fast tree classifier model using the features shown in Table 1.

In some embodiments, the PV model training phase 216 includes determining the weights of the nodes of one or more hidden layers of the PV model (not separately shown). In some embodiments, the weights of the nodes are determined by successively inputting different feature vectors (e.g., a range of positive and negative samples having different feature spaces) into the model and, for each training input, adjusting one or more weights until the SD cards predicted by the PV model to optimize PV match the known labels. In short, weights can be adjusted during the PV model training phase 216 until the PV model provides reasonable (within any level of accuracy, subject only to training time and depth) selections of SD cards to optimize PV. Advantageously, the PV model training phase 216 relies upon fuzzy data (refer to the fuzzy data pipeline 212), and the result is a trained PV model that is free of position bias in a similar manner as discussed with respect to the DAU model. Moreover, observe that, even for the same fuzzy data, the DAU model and the PV model will have different weights due to the different labeling schemes for the positive and negative samples.

In some embodiments, a state of client 202, stored in the service log 210, is provided to state processing module 218. The state can include, for example, a current DAU state 220 of the client 202, such as “IS DAU” or “IS NOT DAU”. Note that the DAU state 220 of the client 202, however set, will by definition reset each 24 hour period.

In some embodiments, a finite state machine 222 retrieves the DAU state 220 from the state processing module 218. In some embodiments, the finite state machine 222 is composed of two or more states. For example, a first state can correspond to the DAU state 220 being set to “IS DAU” (client 202 is already a daily active user) and a second state can correspond to the DAU state 220 being set to “IS NOT DAU” (client 202 is not yet a daily active user).

In some embodiments, the finite state machine 222, depending on the value of the DAU state 220 (that is, whether the client 202 “IS DAU” or “IS NOT DAU”), directs a switching module 224 to trigger an inference phase of a model trained to optimize one of DAU and PV (refer, e.g., to DAU model training phase 214 and PV model training phase 216). For example, in some embodiments, the switching module 224 triggers one of a DAU model inference phase 226 or a PV model inference phase 228 depending on whether the client 202 “IS DAU” or “IS NOT DAU”, respectively.

In particular, when the finite state machine 222 learns from the state processing module 218 that the client 202 is at state “IS NOT DAU”, the switching module 224 can be directed to trigger DAU model inference phase 226 to determine a sequence of SD cards 104 that will optimize a likelihood of converting client 202 from “IS NOT DAU” to “IS DAU”, as the DAU model is trained to optimize DAU conversions as described previously. In some embodiments, the DAU model inference phase 226 outputs a sequence of SD cards 104 having a highest likelihood (e.g., score) for DAU conversion. In some embodiments, the DAU model inference phase 226 outputs the sequence of SD cards 104 responsive to receiving, as input, one or more features (refer to Table 1) of the client 202 and/or the card request 206. The features considered during inference can be referred to herein as real-time data. In some embodiments, the DAU model inference phase 226 outputs the sequence of SD cards 104 according to DAU conversion prediction scores determined according to pre-trained weights set during the DAU model training phase 214.

Similarly, when the finite state machine 222 learns from the state processing module 218 that the client 202 is at state “IS DAU”, the switching module 224 can be directed to trigger PV model inference phase 228 to determine a sequence of SD cards 104 that will optimize a likelihood of increasing PV, as the PV model is trained to generate as many PVs as possible as described previously. In some embodiments, the PV model inference phase 228 outputs a sequence of SD cards 104 having a highest likelihood (e.g., score) for increasing PV. In some embodiments, the PV model inference phase 228 outputs the sequence of SD cards 104 responsive to receiving, as input, one or more features (refer to Table 1) of the client 202 and/or the card request 206. In some embodiments, the PV model inference phase 228 further receives, as an additional input feature(s), card recirculation data from a card recirculation module 230. Card recirculation data can include, for example, a list of interactions (e.g., clicks) with the navigation links 114 stored in the service log 210. In some embodiments, the PV model inference phase 228 outputs the sequence of SD cards 104 according to PV increase prediction scores determined according to pre-trained weights set during the PV model training phase 216.

The following hypothetical scenario illustrates the selection of SD cards 104 for a card response 208 generated by the content selection module 204. Consider that user A first opens (from a respective user device) their browser homepage on August 1 at 9:29 a.m. At this moment user A is at state “NOT DAU”, as no interactions have yet occurred. Responsive to the browser homepage being opened, a card request 206 is sent from the user device (e.g., client 202) to the content selection module 204. A card response 208 including a number of ranked SD cards 104 is returned and used to populate the browser homepage (that is, to set one or more SD cards in a frame of the client 202, refer to FIG. 1A). The selection of SD cards 104 for building the card response 208 is determined according to the DAU model inference phase 226 (that is, the DAU model is triggered to give the sequence of SD cards most likely to achieve DAU conversion). However, user A does not engage with any of the SD cards 104 and closes the browser homepage. Later, user A opens up a new tab page at 9:45 a.m. and the DAU model is triggered again. This time, however, user A clicks a navigation link 114 on an SD card 104 (e.g., a weather card). As a result, a state of user A is transitioned from “IS NOT DAU” to “IS DAU”. If user A opens yet another new tab page, the PV model will be triggered for SD card 104 selection (at least until the “IS DAU” state automatically resets on August 2 at a predetermined DAU reset time, such as at 3:59 a.m.).

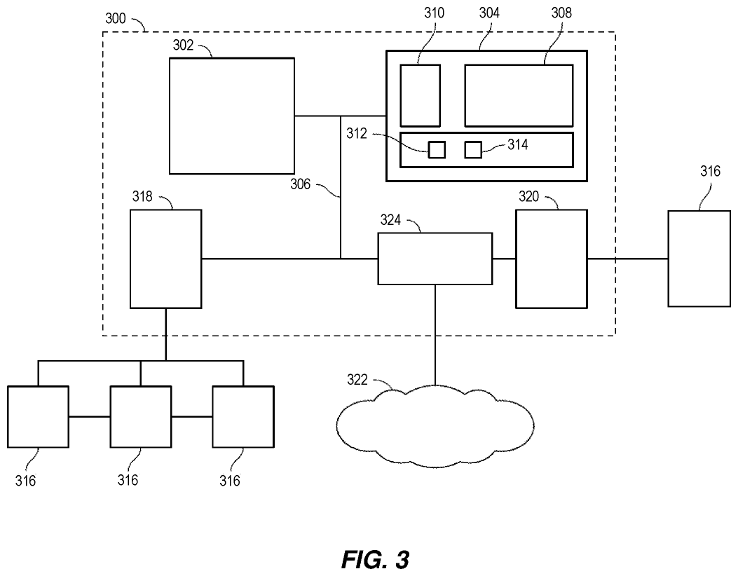

FIG. 3 illustrates aspects of an embodiment of a computer system 300 that can perform various aspects of embodiments described herein. In some embodiments, the computer system(s) 300 can implement and/or otherwise be incorporated within or in combination with a content delivery system (e.g., the content delivery system 100 described with respect to FIG. 1A and/or the content service delivery architecture 200 described with respect to FIG. 2). In some embodiments, a computer system 300 can be implemented server-side. For example, a computer system 300 can be configured to receive card requests 206 and to provide, in response, a card response 208 that includes an ordered list of SD cards 104 as described previously herein.

The computer system 300 includes at least one processing device 302, which generally includes one or more processors or processing units for performing a variety of functions, such as, for example, completing any portion of the workflows described previously herein (model training, model inferencing, SD card selection, etc.). Components of the computer system 300 also include a system memory 304, and a bus 306 that couples various system components including the system memory 304 to the processing device 302. The system memory 304 may include a variety of computer system readable media. Such media can be any available media that is accessible by the processing device 302, and includes both volatile and non-volatile media, and removable and non-removable media. For example, the system memory 304 includes a non-volatile memory 308 such as a hard drive, and may also include a volatile memory 310, such as random access memory (RAM) and/or cache memory. The computer system 300 can further include other removable/non-removable, volatile/non-volatile computer system storage media.

The system memory 304 can include at least one program product having a set (e.g., at least one) of program modules that are configured to carry out functions of the embodiments described herein. For example, the system memory 304 stores various program modules that generally carry out the functions and/or methodologies of embodiments described herein. A module or modules 312, 314 may be included to perform functions related to the workflows described previously herein. The computer system 300 is not so limited, as other modules may be included depending on the desired functionality of the computer system 300. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 302 can also be configured to communicate with one or more external devices 316 such as, for example, a keyboard, a pointing device, and/or any devices (e.g., a network card, a modem, etc.) that enable the processing device 302 to communicate with one or more other computing devices. Communication with various devices can occur via Input/Output (I/O) interfaces 318 and 320.

The processing device 302 may also communicate with one or more networks 322 such as a local area network (LAN), a general wide area network (WAN), a bus network and/or a public network (e.g., the Internet) via a network adapter 324. In some embodiments, the network adapter 324 is or includes an optical network adaptor for communication over an optical network. It should be understood that although not shown, other hardware and/or software components may be used in conjunction with the computer system 300. Examples include, but are not limited to, microcode, device drivers, redundant processing units, external disk drive arrays, RAID systems, and data archival storage systems, etc.

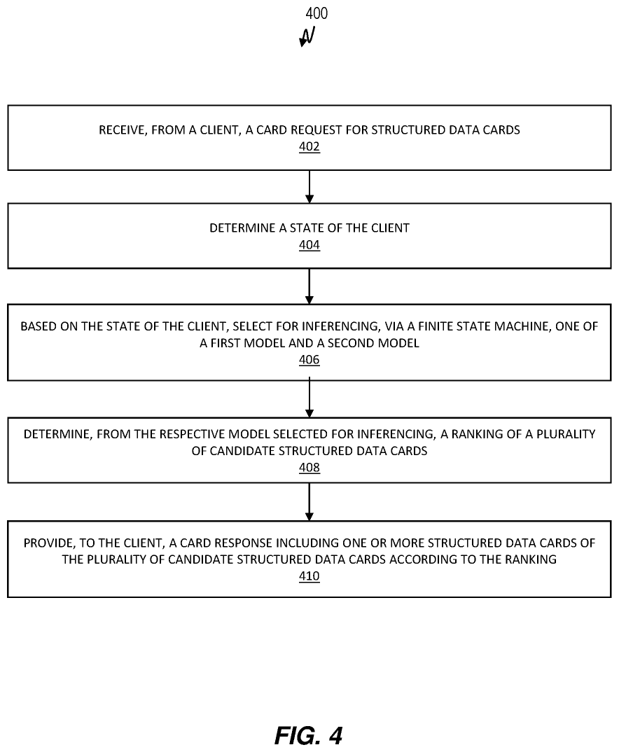

Referring now to FIG. 4, a flowchart 400 for optimizing content service through state-machine based goal programming is generally shown according to an embodiment. The flowchart 400 is described with reference to FIGS. 1A to 3 and may include additional steps not depicted in FIG. 4. Although depicted in a particular order, the blocks depicted in FIG. 4 can be, in some embodiments, rearranged, subdivided, and/or combined.

At block 402, the method includes receiving, from a client, a card request for structured data cards.

At block 404, the method includes determining a state of the client. In some embodiments, determining the state of the client includes determining whether the client is a DAU or non-DAU.

At block 406, the method includes, based on the state of the client, selecting for inferencing, via a finite state machine, one of a first model and a second model.

In some embodiments, the first model is a DAU model trained to rank input structured data cards according to their predictive ability to transition the state of the client from a non-DAU state to a DAU state and the second model is a PV model trained to rank input structured data cards according to their predictive ability to increase a number of PVs of the client.

In some embodiments, the first model is trained on training data that includes samples labeled as positive samples and negative samples according to whether each respective sample includes at least one of a first feature and a second feature. In some embodiments, the second model is trained on the training data, but the training data is relabeled according to whether each respective sample includes the first feature. In some embodiments, when the second model is trained, the positive samples and negative samples are labeled without regard to the second feature. In some embodiments, at least one sample assigned a positive label in the first set of positive labels is assigned a negative label in the second set of negative labels.

At block 408, the method includes determining, from the respective model selected for inferencing, a ranking of a plurality of candidate structured data cards.

At block 410, the method includes providing, to the client, a card response including one or more structured data cards of the plurality of candidate structured data cards according to the ranking.

In some embodiments, when the first model is selected for inferencing, the method includes receiving, as input, one or more features of the client and one or more features of the card request and generating, as output, a sequence of structured data cards of the plurality of candidate structured data cards having a highest predictive ability to transition the state of the client from the non-DAU state to the DAU state. In some embodiments, when the second model is selected for inferencing, the method includes receiving, as input, one or more features of the client and one or more features of the card request and generating, as output, a sequence of structured data cards of the plurality of candidate structured data cards having a highest predictive ability to increase a number of PVs of the client.

In some embodiments, the method includes determining that the client is in the non-DAU state, selecting, via the finite state machine, the first model for inferencing, and providing, to the client, one or more structured data cards of the plurality of candidate structured data cards having a highest predictive ability to transition the state of the client from the non-DAU state to the DAU state.

In some embodiments, the method includes determining that the client is in the DAU state, selecting, via the finite state machine, the second model for inferencing, and providing, to the client, one or more structured data cards of the plurality of candidate structured data cards having a highest predictive ability to increase a number of PVs of the client.

In some embodiments, the method includes extracting, from a service log including prior interactions of the client with structured data cards, fuzzy data including a predetermined subset of the prior interactions in which all structured data cards provided to the client are assigned a random ranking. In some embodiments, the method includes training the DAU model and the PV model on training data that only includes the fuzzy data, thereby removing position bias from the respective model training.

In some embodiments, the method includes providing a switching module coupled to the finite state machine. In some embodiments, the switching module is configured to select one of the first model and the second model for inferencing. In some embodiments, the switching module selects the first model when the finite state machine is in the first state and the second model when the finite state machine is in the second state.

In some embodiments, the method includes providing a service log configured to record features of interactions between a client and structured data cards. In some embodiments, the method includes providing a fuzzy data pipeline coupled to the service log, the fuzzy data pipeline configured to extract, from the service log, fuzzy data including features of interactions between the client and randomly ranked structured data cards.

In some embodiments, the method includes providing a state processing module coupled to the service log. In some embodiments, the method includes extracting, from the service log, a current state of the client. In some embodiments, the method includes providing a card recirculation module coupled to the service log. The card recirculation module is configured to extract, from the service log, card recirculation data including one or more client interactions with a navigation link of a respective structured data card.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of this disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for optimizing content service through state-machine based goal programming, the method comprising:
receiving, from a client, a card request for structured data cards;
determining a state of the client;
based on the state of the client, selecting for inferencing, via a finite state machine, one of a first model and a second model;
determining, from the respective model selected for inferencing, a ranking of a plurality of candidate structured data cards; and
providing, to the client, a card response comprising one or more structured data cards of the plurality of candidate structured data cards according to the ranking.

2. The method of claim 1, wherein determining the state of the client comprises determining whether the client is a daily active user (DAU) or a non-daily active user (non-DAU), and wherein the first model comprises a daily active user (DAU) model trained to rank input structured data cards according to their predictive ability to transition the state of the client from a non-DAU state to a DAU state and the second model comprises a page view (PV) model trained to rank input structured data cards according to their predictive ability to increase a number of PVs of the client.

3. The method of claim 2, further comprising:
when the first model is selected for inferencing:
receiving, as input, one or more features of the client and one or more features of the card request; and
generating, as output, a sequence of structured data cards of the plurality of candidate structured data cards having a highest predictive ability to transition the state of the client from the non-DAU state to the DAU state; and
when the second model is selected for inferencing:
receiving, as input, one or more features of the client and one or more features of the card request; and
generating, as output, a sequence of structured data cards of the plurality of candidate structured data cards having a highest predictive ability to increase a number of PVs of the client.

4. The method of claim 2, further comprising:
determining that the client is in the non-DAU state;
selecting, via the finite state machine, the first model for inferencing; and
providing, to the client, one or more structured data cards of the plurality of candidate structured data cards having a highest predictive ability to transition the state of the client from the non-DAU state to the DAU state.

5. The method of claim 2, further comprising:
determining that the client is in the DAU state;
selecting, via the finite state machine, the second model for inferencing; and
providing, to the client, one or more structured data cards of the plurality of candidate structured data cards having a highest predictive ability to increase a number of PVs of the client.

6. The method of claim 2, further comprising extracting, from a service log comprising prior interactions of the client with structured data cards, fuzzy data comprising a predetermined subset of the prior interactions in which all structured data cards provided to the client are assigned a random ranking.

7. The method of claim 6, further comprising training the DAU model and the PV model on training data that only includes the fuzzy data, thereby removing position bias from the respective model training.

8. A system comprising:
a finite state machine comprising a first state and a second state;
a first model trained on training data, the training data comprising samples labeled as positive samples and negative samples according to whether each respective sample includes at least one of a first feature and a second feature;
a second model trained on the training data, the training data comprising samples labeled as positive samples and negative samples according to whether each respective sample includes the first feature; and
a switching module coupled to the finite state machine, the switching module configured to select one of the first model and the second model for inferencing, wherein the switching module selects the first model when the finite state machine is in the first state and the second model when the finite state machine is in the second state.

9. The system of claim 8, wherein, when the second model is trained, the positive samples and negative samples are labeled without regard to the second feature.

10. The system of claim 8, further comprising a service log configured to record features of interactions between a client and structured data cards.

11. The system of claim 10, further comprising a fuzzy data pipeline coupled to the service log, the fuzzy data pipeline configured to extract, from the service log, fuzzy data comprising features of interactions between the client and randomly ranked structured data cards.

12. The system of claim 11, wherein the first model and the second model are trained, during respective training phases, on training data that is only sourced from the fuzzy data.

13. The system of claim 10, further comprising a state processing module coupled to the service log, the state processing module configured to extract, from the service log, a current state of the client.

14. The system of claim 10, further comprising a card recirculation module coupled to the service log, the card recirculation module configured to extract, from the service log, card recirculation data comprising one or more client interactions with a navigation link of a respective structured data card.

15. A computer program product comprising a computer readable storage medium having program instructions embodied therewith, the program instructions executable by one or more processors to cause the one or more processors to perform operations comprising:
labeling training data by assigning a first set of positive labels and a first set of negative labels to samples in the training data according to whether each respective sample includes at least one of a first feature and a second feature;
labeling the training data by assigning a second set of positive labels and a second set of negative labels to the samples according to whether each respective sample includes the first feature;
training a first model on the first set of positive labels and the first set of negative labels;
training a second model on the second set of positive labels and the second set of negative labels; and
selecting one of the first model and the second model for inferencing based on a state of a finite state machine.

16. The computer program product of claim 15, wherein at least one sample assigned a positive label in the first set of positive labels is assigned a negative label in the second set of negative labels.

17. The computer program product of claim 15, wherein the state of the finite state machine is a first state when a client is a daily active user (DAU) and a second state when the client is a non-daily active user (non-DAU).

18. The computer program product of claim 17, wherein the first model comprises a DAU model trained to rank input structured data cards according to their predictive ability to transition the client from a non-DAU state to a DAU state and the second model comprises a PV model trained to rank input structured data cards according to their predictive ability to increase a number of PVs of the client.

19. The computer program product of claim 18, wherein selecting one of the first model and the second model comprises selecting the first model when the client is a non-DAU and selecting the second model when the client is a DAU.

20. The computer program product of claim 18, wherein the training data comprises fuzzy data comprising features of interactions between clients and randomly ranked structured data cards.
